(19) United States
(12) Patent Application Publication
(10) Pub. No.: US 2007/0193548 A1
(43) Pub. Date: Aug. 23, 2007

(54) Multi-port piston and internal combustion engine

(76) Inventors: Daniel Floyd Bauman SR., Shade, OH (US); Daniel Floyd Bauman JR., Logan, OH (US)

Correspondence Address: Raymond M. Galasso;Galasso & Associates LP, P.O. Box 26503, Austin, TX, 78755-0503, US

(21) Appl. No.: 11/359,221

(22) Filed: Feb. 21, 2006

(51) Int. Cl. F02F 3/00

(52) U.S. Cl. 123/193.6; 123/193.1

(57) ABSTRACT

A two-stroke engine utilizing a piston with two sets of intake ports, such that the first set of intake ports of the piston are positioned on the piston such that it is in alignment with the fuel intake when the piston has cycled to the bottom position, permitting the flow of fuel into the crankcase. The second set of intake ports of the piston are positioned such that they are at least partially in alignment with the fuel intake when the piston is cycling from the bottom position to the compression position, permitting the flow of fuel into the crankcase during the alignment.

### FIELD OF THE INVENTION

The present invention relates two stroke engines, and more specifically but not by way of limitation, to a two-stroke engine utilizing multi-port pistons to increase the amount of fuel directed into the crankcase of the engine by the vacuum created during the upward stroke of the piston.

### BACKGROUND

Two-stroke engines are found in devices such as chain saws and personal watercraft because two-stroke engines have some important advantages over four-stroke engines. Two-stroke engines do not have valves, which simplifies their construction and lowers their weight.

Two-stroke engines fire once every revolution, while four-stroke engines fire once every other revolution. This gives two-stroke engines a significant power boost. Two-stroke engines can work in any orientation, which can be important in something like a chainsaw. A standard four-stroke engine may have problems with oil flow unless it is upright, and solving this problem can add complexity to the engine.

These advantages make two-stroke engines lighter, simpler and less expensive to manufacture. Two-stroke engines also have the potential to pack about twice the power into the same space as a four-stroke engine because there are twice as many power strokes per revolution.

The combination of lightweight and twice the power gives two-stroke engines a great power-to-weight ration compared too many four-stroke engine designs.

In a typical two-stroke reed valve engine, the operation cycle is straightforward. When the fuel and air in the cylinder have been compressed by the piston, the spark plug fires igniting the fuel mixture. The resulting explosion drives the piston downward. When the piston moves downward, it compresses the air/fuel mixture in the crankcase. As the piston approaches the bottom of its stroke, the exhaust port is uncovered. The pressure in the cylinder drives most of the exhaust gases out of cylinder.

As the piston finally bottoms out, the intake port is uncovered. Because the piston's movement has pressurized the mixture in the crankcase, the mixture in the crankcase rushes into the cylinder, displacing the remaining exhaust gases and filling the cylinder with a fresh charge of fuel.

The momentum in the crankshaft starts driving the piston back toward the spark plug for the compression stroke. As the air/fuel mixture in the piston is compressed, a vacuum is created in the crankcase. This vacuum opens the reed valve and sucks air/fuel/oil in from the carburetor.

Once the piston makes it to the end of the compression stroke, the spark plug fires again to repeat the cycle.

The piston is doing three different things in a two-stroke engine. On one side of the piston is the combustion chamber, where the piston is compressing the air/fuel mixture and capturing the energy released by the ignition of the fuel. On the other side of the piston is the crankcase, where the piston is creating a vacuum to suck in air/fuel from the carburetor through the reed valve and then pressurizing the crankcase so that air/fuel is forced into the combustion chamber.

The sides of the piston are acting like valves, covering and uncovering the intake and exhaust ports.

As can be appreciated with all types of engines there is a desire to improve the amount power generated by an engine, especially with two-stroke engines where the types of use of the engine dictates that the space for the engine is very limited.

### SUMMARY OF THE INVENTION

It is the object of the present invention to provide an internal combustion two-stroke engine with improved power output.

It is another object of the present invention to provide a two-stroke engine utilizing multiple offset intake ports on the pistons to increase the amount of fuel mixture that can enter the engine per stroke, as well as provide additional lubrication.

To the accomplishment of the above and related objects, the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a top perspective view of a piston in accordance with an embodiment of the present invention; and

FIG. 2 is a side view of an embodiment of the present invention illustrating a piston within a sectional view of a two-stroke engine.

### DETAILED DESCRIPTION

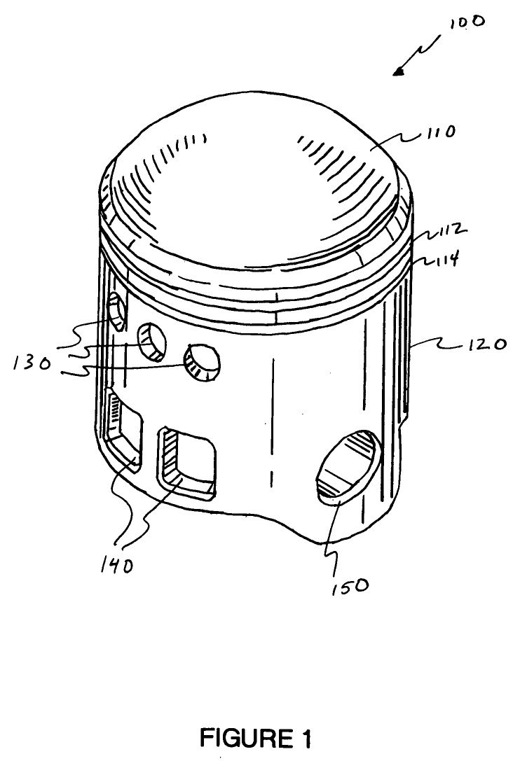

Referring now to the Figures, wherein the various elements depicted therein are not necessarily drawn to scale, and wherein like elements are designated with identical reference numerals throughout the views and Figures, and in particular to FIG. 1 there is illustrated a piston 100 constructed according to the principles of the present invention.

Piston 100 includes a head 110, piston rings 112 and 114, and a body 120. Head 110 is generally solid, while body 120 is hollow and generally cylindrical in shape and extends down from head 110. Body 120 includes two sets of intake ports 130 and 140, with intake ports 130 and 140 being offset from each other, with intake ports 130 more proximate head 110 than intake ports 140. A hole 150 is configured to receive a connecting rod. Intake ports 130 and 140 are holes, which extend from through the wall of body 120. In the preferred embodiment, intake ports 130 include 3 generally circular holes, and intake ports 140 include 2 generally square holes, however, it is contemplated to be within the scope of this invention that the number, shape, and size of ports for each of intake ports 130 and 140 could be varied based upon a number of factors, including but not limited to the size of the body 120 and a users preference. For example, but not by way of limitation, good results have been achieved with intake ports 130 being three-eighths of an inch holes, located one-eighth of an inch below piston ring 114.

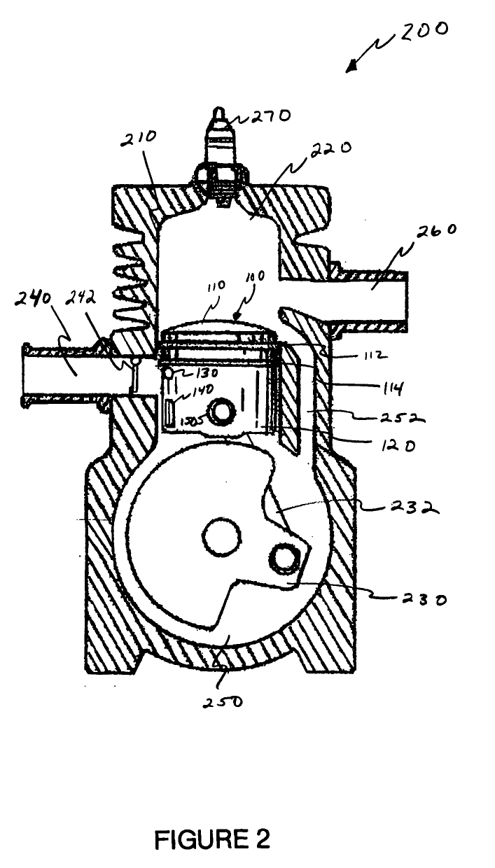

Referring now to FIG. 2, there is illustrated sectional view of a two-stroke-engine 200 utilizing piston 100. Two-stroke engine 200 includes a cylinder 210 with a portion of cylinder 210 forming a combustion chamber 220. Combustion chamber 220 is delimited by piston 100, which is reciprocally moveable in cylinder 210. Piston 100 drives a crankshaft 230 via a connecting rod 232. The crankshaft 230 is rotatably positioned within crankcase 250. Crankcase 250 is connected to combustion chamber 220 via transfer channel 252 and permits the flow of the fuel/mixture from crankcase 250 to combustion chamber 220 when the head 110 of piston 100 is below the upper opening of transfer channel 252.

Two-stroke engine 200 includes an intake channel 240, which opens into cylinder 210. Intake channel 240 is configured to deliver an air/fuel mixture to two-stroke engine 200 from a carburetor. A reed valve 242 is connected within channel 240 to permit the flow of the air/fuel mixture from the carburetor to cylinder 210 and to inhibit the flow of any exhaust or air/fuel mixture from cylinder 210 back into intake channel 240.

Two-stroke engine 200 includes an exhaust 260, which opens up and leads out from combustion chamber 220. Exhaust 260 is configured to discharge exhaust materials from combustion chamber 220.

Two-stroke engine 200 also includes a spark plug 270, which is mounted at the top of two-stroke engine 200 and extends into combustion chamber 220.

Referring now to FIGS. 1 and 2 the operation cycle of two-stroke engine 200 will now be described. When piston 100 cycles in the up position, the air/fuel mixture in cylinder 210 is can be compressed by piston 100 because the body 120 of piston 100 blocks off both the exhaust 260 and transfer channel 252. The spark plug 270 then fires igniting the air/fuel mixture. The resulting explosion drives piston 100 downward. As the piston 100 is driven downward, the air/fuel mixture in crankcase 250 is compressed. The compression of the air/fuel mixture in crankcase 250 closes reed valve 272. As the exhaust 260 becomes uncovered, the pressure in cylinder 210 drives most of the exhaust gases out of cylinder 210 through exhaust 260.

As piston 100 bottoms out, piston 100 clears transfer channel 252 such that transfer channel 252 becomes uncovered. Because of the pressure of air/fuel mixture in crankcase 250 created by piston 100, the air/fuel mixture traverses through transfer channel 252 into the cylinder 210, displacing the remaining exhaust gases and filling cylinder 210 with a fresh charge of fuel. While piston 100 is bottomed out, intake ports 130 are in alignment with intake 240. As the pressure in crankcase 250 decreases as a result of the air/fuel mixture traversing through transfer channel 252 into cylinder 210, reed valve 242 opens allowing air/fuel mixture from intake 240 to traverse through intake ports 130 and into crankcase 250.

The momentum in crankshaft 230 starts to drive piston 100 back toward spark plug 270 for the compression stroke. As piston 100 closes off transfer channel 252, a vacuum is created in crankcase 250. The intake ports 140 then come into alignment with intake 240 during the compression stroke. When this occurs, the vacuum in crankcase 250 opens the reed valve and sucks additional air/fuel mixture from intake 240, through intake ports 130 and into crankcase 250.

Once piston 100 makes it to the end of the compression stroke, spark plug 270 fires again to repeat the cycle.

Having two sets of intake ports 130 and 140 has numerous advantages over a standard ported two-stroke engine of the same size. The air/fuel mixture is utilized more efficiently by engine 200. The amount of air/fuel mixture that is transferred into crankshaft 250 per cycle is increased, which in turn, increase the amount of air/fuel mixture that is transferred into cylinder 210 per cycle, creating a greater combustion, thereby increasing the horse power. Having two sets of intake ports 130 and 140 also helps to maintain the structural integrity of piston 100, while maximizing the air/fuel flow and horse power. Maximizing the air/fuel flow into crankshaft 250 also creates better lubrication for engine 200.

Although engine 200 is illustrated with only one cylinder 100, it is understood and contemplated that the present invention is applicable to other types of engines with any number of cylinders.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A piston for an internal combustion engine, comprising:
a head;
a hollow body portion cylindrically extending from said head; and
said body portion including a first intake port positioned proximate said head, and said body portion including at second intake port positioned offset from said first intake port and distal from said head.

2. The piston as recited in claim 1, wherein said first intake port is positioned above said second intake port when the piston is oriented with said body in a vertical position with said head on the top.

3. The piston as recited in claim 2, and further comprising a third intake port positioned beside said first intake port and offset from said second intake port.

4. The piston as recited in claim 3, and further comprising a fourth, intake port positioned beside said second intake port and offset from said first and third intake ports.

5. The piston as recited in claim 4, wherein each of said first intake port and said third intake ports or three-eighths of an inch in diameter.

6. A two-stroke engine comprising:
a cylinder;
a piston within said cylinder, said piston movable between a compression position and a bottom position, said piston including a head portion and a hollow body portion cylindrically extending from said head portion;
a crankcase connected to said cylinder;
a crankshaft rotatably mounted in said crankcase, said crankshaft rotatably connected to said piston such that when said piston cycles between said compression position and said bottom position, said crankshaft rotates;
an fuel intake connected to said cylinder, said fuel intake for delivering fuel to the engine; and
said piston including a first intake port through said body portion, said first intake port positioned on said body portion to be in alignment with said fuel intake when said piston is in said bottom position permitting fuel to transfer from said fuel intake through said first intake port and into said crankcase.

7. The two-stroke engine as recited in claim 6, further including a reed valve positioned in said fuel intake.

8. The two-stroke engine as recited in claim 7, wherein said piston includes a second intake port through said body portion, said second intake port positioned offset from said first intake port.

9. The two-stroke engine as recited in claim 8, wherein said second intake port is operable with said reed valve to permit fuel to transfer from said fuel intake through said second intake port and into said crankcase when at least a portion of said second intake port is in alignment with said fuel intake when said piston is moving from said bottom position to said compression position.

10. The two-stroke engine as recited in claim 9, wherein said piston includes a third intake port through said body portion, said third intake port positioned proximate to said first intake port and offset from said second intake port.

11. The two-stroke engine as recited in claim 10, wherein said third intake port is positioned on said body portion to be in alignment with said fuel intake when said piston is in said bottom position permitting fuel to transfer from said fuel intake through said third intake port and into said crankcase.

12. The two-stroke engine as recited in claims 11, wherein said piston includes a fourth intake port through said body portion, said fourth second intake port positioned proximate said second intake port and offset from said first and third intake ports.

13. The two-stroke engine as recited in claim 12, wherein said fourth intake port is operable with said reed valve to permit fuel to transfer from said fuel intake through said fourth intake port and into said crankcase when at least a portion of said fourth intake port is in alignment with said fuel intake when said piston is moving from said bottom position to said compression position.

14. A two-stroke engine comprising:
a cylinder;
a piston within said cylinder, said piston movable between a compression position and a bottom position, said piston including a head portion and a hollow body portion cylindrically extending from said head portion;
a crankcase connected to said cylinder;
a crankshaft rotatably mounted in said crankcase, said crankshaft rotatably connected to said piston such that when said piston cycles between said compression position and said bottom position, said crankshaft rotates;
an fuel intake connected to said cylinder, said fuel intake for delivering fuel to the engine;
a transfer channel connected intermediate said crankcase and said cylinder; and
said piston including a first intake port through said body portion, said first intake port positioned on said body portion to be in alignment with said fuel intake when said piston is in said bottom position permitting fuel to transfer from said fuel intake through said first intake port and into said crankcase.

15. The two-stroke engine as recited in claim 14, further including a reed valve positioned in said fuel intake.

16. The two-stroke engine as recited in claim 15, wherein said piston includes a second intake port through said body portion, said second intake port positioned offset from said first intake port, said second intake port is operable with said reed valve to permit fuel to transfer from said fuel intake through said second intake port and into said crankcase when at least a portion of said second intake port is in alignment with said fuel intake when said piston is moving from said bottom position to said compression position.

17. The two-stroke engine as recited in claim 16, wherein said piston includes a third intake port through said body portion, said third intake port positioned proximate to said first intake port and offset from said second intake port.

18. The two-stroke engine as recited in claim 17, wherein said third intake port is positioned on said body portion to be in alignment with said fuel intake when said piston is in said bottom position permitting fuel to transfer from said fuel intake through said third intake port and into said crankcase.

19. The two-stroke engine as recited in claim 18, wherein said piston includes a fourth intake port through said body portion, said fourth second intake port positioned proximate said second intake port and offset from said first and third intake ports.

20. The two-stroke engine as recited in claim 19, wherein said fourth intake port is operable with said reed valve to permit fuel to transfer from said fuel intake through said fourth intake port and into said crankcase when at least a portion of said fourth intake port is in alignment with said fuel intake when said piston is moving from said bottom position to said compression position.
